(19) United States
(12) Patent Application Publication
(10) Pub. No.: US 2018/0129301 A1
(43) Pub. Date: May 10, 2018

(54) METHOD AND SYSTEM PROVIDING CUSTOMIZABLE USER INTERFACE CONTROLS POSITIONABLE AT A MEDICAL IMAGING SYSTEM

(71) Applicant: General Electric Company, Schenectady, NY (US)

(72) Inventors: Johann Himsl, Zipf (AT); Klaus Pintoffl, Zipf (AT)

(21) Appl. No.: 15/343,395

(22) Filed: Nov. 4, 2016

(51) Int. Cl. G06F 3/023; G06F 19/00

(52) U.S. Cl. CPC G06F 3/0238; G06F 19/3418; G06F 19/321

(57) ABSTRACT

A custom user input module having an input functionality is selectively placed at and/or in communication range of a medical imaging system. A signal processor of the medical imaging system detects a presence of the custom user input module to establish a connection between the custom user input module and the medical imaging system. The signal processor receives instructions associating the input functionality of the custom user input module with an action of the medical imaging system. The signal processor maps the input functionality with the action of the medical imaging system based on the received instructions. The signal processor receives a signal corresponding with the input functionality of the custom user input module. The signal processor executes the action of the medical imaging system mapped to the input functionality of the custom user input module based on the received signal.

### REFERENCE

[Not Applicable]

### FIELD

Certain embodiments relate to medical imaging system user input controls. More specifically, certain embodiments relate to a method and system providing customizable user interface controls that can be positioned at multiple locations on and/or around an ultrasound system or other medical imaging system.

### BACKGROUND

Ultrasound machines and other medical imaging systems include user interface controls. The user interface controls may include a trackball, traditional buttons, rotary encoders, sliders, and the like. The user interface controls are provided at fixed positions on the medical imaging device, such as on a control panel. Each of the user interface controls is typically associated with a particular function, such as start/stop functionality. Medical imaging system operators have different workflows. Accordingly, the fixed positions of the user interface controls may be inconvenient and/or uncomfortable, thereby making the medical imaging system operators less efficient. For example, user interface controls may be out of reach of the medical imaging system operator if the operator is on an opposite side of the machine when scanning.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY

A system and/or method providing customizable user interface controls that can be positioned at multiple locations on and/or around an ultrasound system or other medical imaging system is provided, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary ultrasound system having customizable user interface controls, in accordance with various embodiments.

FIG. 2 is a side view of exemplary customizable user interface controls, in accordance with various embodiments.

FIG. 3 is a perspective of an exemplary attachment mechanism for customizable user interface controls, in accordance with various embodiments.

FIG. 4 is a side view of exemplary customizable user interface controls provided in an exemplary attachment mechanism, in accordance with various embodiments.

FIG. 5 is a cross-sectional view of an exemplary ultrasound probe having receivers configured to cooperate with transmitters of customizable user interface controls, in accordance with various embodiments.

FIG. 6 is a perspective view of an exemplary ultrasound probe having exemplary customizable user interface controls positioned on the probe by an exemplary attachment mechanism, in accordance with various embodiments.

FIG. 7 is a front view of an exemplary ultrasound system control panel having slots for receiving customizable user interface controls, in accordance with various embodiments.

FIG. 8 is a cross-sectional view of an exemplary ultrasound system control panel receiving a customizable user interface control, in accordance with various embodiments.

FIG. 9 is a screenshot of an exemplary configuration dialog configured to present configuration options of a customizable user interface control, in accordance with various embodiments.

FIG. 10 is a flow chart illustrating exemplary steps that may be utilized for positioning, configuring, and controlling a medical imaging system using customizable user interface controls, in accordance with various embodiments.

### DETAILED DESCRIPTION

Certain embodiments may be found in a method and system for providing customizable user interface controls (also referred to as custom user input modules) that can be positioned at multiple locations on and/or around an ultrasound system or other medical imaging system. For example, aspects of the present invention have the technical effect of providing a medical imaging system configured to detect the presence of a custom user input module positioned on or in the vicinity of the medical imaging system. Moreover, aspects of the present invention have the technical effect of allowing medical imaging system operators to configure custom user input modules by mapping available inputs of the custom user input modules to actions of the medical imaging system.

The foregoing summary, as well as the following detailed description of certain embodiments will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block of random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings. It should also be understood that the embodiments may be combined, or that other embodiments may be utilized and that structural, logical and electrical changes may be made without departing from the scope of the various embodiments of the present invention. The following detailed description is, therefore, not to be taken in a limiting sense, and the scope of the present invention is defined by the appended claims and their equivalents.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Also as used herein, the term “image” broadly refers to both viewable images and data representing a viewable image. However, many embodiments generate (or are configured to generate) at least one viewable image. In addition, as used herein, the phrase “image” is used to refer to an ultrasound mode such as B-mode, CF-mode and/or sub-modes of CF such as TVI, Angio, B-flow, BMI, BMI_Angio, and in some cases also MM, CM, PW, TVD, CW where the “image” and/or “plane” includes a single beam or multiple beams.

Furthermore, the term processor or processing unit, as used herein, refers to any type of processing unit that can carry out the required calculations needed for the invention, such as single or multi-core: CPU, Graphics Board, DSP, FPGA, ASIC or a combination thereof.

It should be noted that various embodiments described herein that generate or form images may include processing for forming images that in some embodiments includes beamforming and in other embodiments does not include beamforming. For example, an image can be formed without beamforming, such as by multiplying the matrix of demodulated data by a matrix of coefficients so that the product is the image, and wherein the process does not form any “beams”. Also, forming of images may be performed using channel combinations that may originate from more than one transmit event (e.g., synthetic aperture techniques).

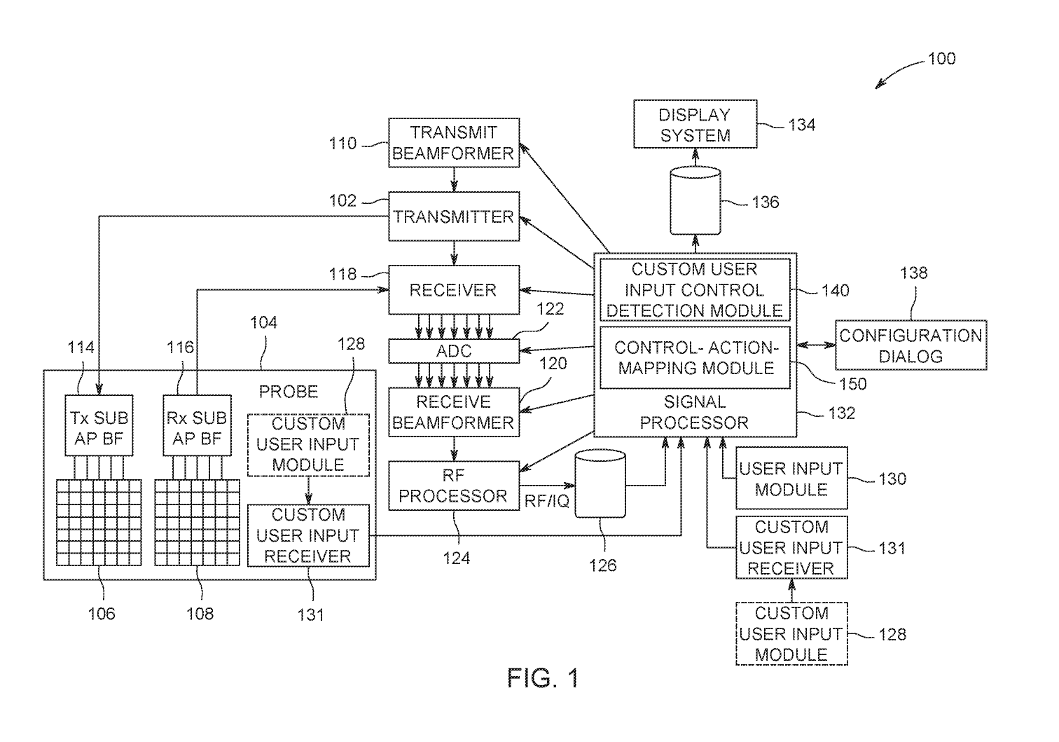

In various embodiments, ultrasound processing to form images is performed, for example, including ultrasound beamforming, such as receive beamforming, in software, firmware, hardware, or a combination thereof. One implementation of an ultrasound system having a software beamformer architecture formed in accordance with various embodiments is illustrated in FIG. 1.

FIG. 1 is a block diagram of an exemplary ultrasound system 100 having customizable user interface controls 128, in accordance with various embodiments. Referring to FIG. 1, there is shown an ultrasound system 100 comprising a transmitter 102, an ultrasound probe 104, a transmit beamformer 110, a receiver 118, a receive beamformer 120, a RF processor 124, a RF/IQ buffer 126, a user input module 130, custom user input receiver(s) 131, custom user input module(s) 128, a signal processor 132, an image buffer 136, and a display system 134.

The transmitter 102 may comprise suitable logic, circuitry, interfaces and/or code that may be operable to drive an ultrasound probe 104. The ultrasound probe 104 may comprise a one dimensional (1D, 1.25D, 1.5D or 1.75D) array or two dimensional (2D) array of piezoelectric elements. The ultrasound probe 104 may comprise a group of transmit transducer elements 106 and a group of receive transducer elements 108, that normally constitute the same elements.

The transmit beamformer 110 may comprise suitable logic, circuitry, interfaces and/or code that may be operable to control the transmitter 102 which, through a transmit sub-aperture beamformer 114, drives the group of transmit transducer elements 106 to emit ultrasonic transmit signals into a region of interest (e.g., human, animal, underground cavity, physical structure and the like). The transmitted ultrasonic signals 107 may be back-scattered from structures in the object of interest, like blood cells or tissue, to produce echoes. The echoes are received by the receive transducer elements 108. The group of receive transducer elements 108 in the ultrasound probe 104 may be operable to convert the received echoes into analog signals, undergo sub-aperture beamforming by a receive sub-aperture beamformer 116 and are then communicated to a receiver 118.

The receiver 118 may comprise suitable logic, circuitry, interfaces and/or code that may be operable to receive and demodulate the signals from the receive sub-aperture beamformer 116. The demodulated analog signals may be communicated to one or more of the plurality of A/D converters 122. The plurality of A/D converters 122 may comprise suitable logic, circuitry, interfaces and/or code that may be operable to convert the demodulated analog signals from the receiver 118 to corresponding digital signals. The plurality of A/D converters 122 are disposed between the receiver 118 and the receive beamformer 120. Notwithstanding, the invention is not limited in this regard. Accordingly, in some embodiments, the plurality of A/D converters 122 may be integrated within the receiver 118.

The receive beamformer 120 may comprise suitable logic, circuitry, interfaces and/or code that may be operable to perform digital beamforming processing on the signals received from the plurality of A/D converters 122. The resulting processed information may be converted back to corresponding RF signals. The corresponding output RF signals that are output from the receive beamformer 120 may be communicated to the RF processor 124. In accordance with some embodiments, the receiver 118, the plurality of A/D converters 122, and the beamformer 120 may be integrated into a single beamformer, which may be digital.

The RF processor 124 may comprise suitable logic, circuitry, interfaces and/or code that may be operable to demodulate the RF signals. In accordance with an embodiment, the RF processor 124 may comprise a complex demodulator (not shown) that is operable to demodulate the RF signals to form I/Q data pairs that are representative of the corresponding echo signals. The RF or I/Q signal data may then be communicated to an RF/IQ buffer 126. The RF/IQ buffer 126 may comprise suitable logic, circuitry, interfaces and/or code that may be operable to provide temporary storage of the RF or I/Q signal data, which is generated by the RF processor 124.

The user input module 130 and/or custom user input module 128 may be utilized to input patient data, image acquisition and scan parameters, image viewing parameters, settings, configuration parameters, change scan mode, start and stop scanning, and the like. In an exemplary embodiment, the user input module 130 and custom user input module 128 may be operable to configure, manage and/or control operation of one or more components and/or modules in the ultrasound system 100. In this regard, the user input module 130 and custom user input module 128 may be operable to configure, manage and/or control operation of transmitter 102, the ultrasound probe 104, the transmit beamformer 110, the receiver 118, the receive beamformer 120, the A/D converters 122, the RF processor 124, the RF/IQ buffer 126, the user input module 130, the custom user input module 128, the signal processor 132, the image buffer 136, and/or the display system 134.

The user input module 130 may include physical control devices provided and/or integrated at generally fixed locations on the ultrasound system 100. For example, the user input module 130 can include a trackball, mousing device, keyboard, touch screen display, remote control, button, switch, rotary encoder, sliding bar, and/or voice activated input, among other things. The user input module 130 may be integrated with other components, such as the ultrasound probe 104, display system 134 or control panel, or can be a separate component.

The custom user input module 128 may include physical control devices, such as a button, rotary encoder, slider, or any suitable device or mechanism operable to receive a user input. The custom user input module 128 may include separate, stand alone devices that may be added to an ultrasound system 100 at user-selected locations on or in the vicinity of the ultrasound system 100. For example, the custom user input module 128 may include physical buttons, rotary encoders, sliders, and/or the like that wirelessly connect with the ultrasound system 100.

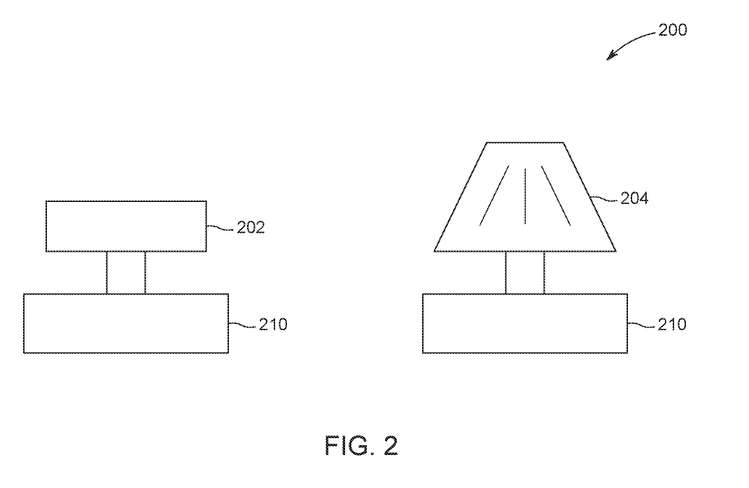

FIG. 2 is a side view of exemplary customizable user interface controls 200, in accordance with various embodiments. The customizable user interface controls 200 of FIG. 2 may correspond with the custom user input module 128 of FIG. 1. Referring to FIG. 2, the customizable user interface controls 200 comprise a user input portion 202, 204 and a base portion 210. The user input portion 202 may be a button 202, rotary encoder 204, slider, or any suitable device or mechanism operable to receive a user input. The user input portion 202, 204 is configured to generate a signal in response to receiving a user input, such as a press action, rotary action, sliding action, or the like. The base portion 210 comprises a transmitter configured to receive the signal generated by user input portion 202, 204. The received signal may be encoded by the transmitter prior to wireless transmission. The customizable user interface controls 200 may be configured to transmit the encoded signal using near field communication (NFC), Bluetooth, Wi-Fi, or any suitable wireless technology. In various embodiments, the base portion 210 may be mounted on or in the vicinity of a medical imaging system in a position convenient for the system operator. In certain embodiments, the base portion 210 may include a battery for powering the customizable user interface controls 200. Additionally and/or alternatively, the customizable user interface controls 200 may be powered by induction when the controls 200 are placed on the medical imaging system 100, by harvesting energy from operation of the controls 200, such as by pressing or turning the controls 200, and/or by any suitable mechanism for providing power to the controls 200.

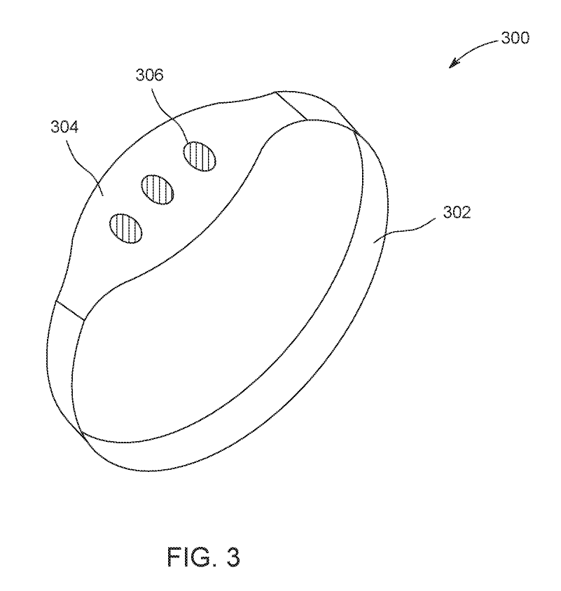

Referring again to FIG. 1, the custom user input module 128 may be mounted to or near the ultrasound system 100 via an attachment mechanism, such as magnets, hook and loop fasteners, clips, snaps, bands, straps, or any suitable attachment mechanism. FIG. 3 is a perspective of an exemplary attachment mechanism 300 for customizable user interface controls 128, 200, in accordance with various embodiments. Referring to FIG. 3, the attachment mechanism 300 comprises a band portion 302 and a mounting portion 304. The band portion 302 may be rubber or any suitable flexible material for wrapping around and securing to a component of a medical imaging system, such as a probe 104 of an ultrasound system 100 or any suitable component. Additionally and/or alternatively, the band portion 302 may comprise two straps configured to wrap around a component of a medical imaging system, where the straps are detachably coupled to form the band portion 302 for securing the attachment mechanism to the component of the medical imaging system. For example, the straps may be detachably coupled by hook and loop fasteners, clips, snaps, or any suitable coupling mechanism. The mounting portion 304 may be attached to and/or integrated with the band portion 302. The mounting portion 304 comprises mounting elements 306 for detachably coupling the custom user input module 128, 200 to the attachment mechanism 300. The mounting elements 306 may be apertures, magnets, hook and loop fasteners, clips, snaps, or any suitable mechanism for detachably coupling the custom user input module 128, 200 to the mounting portion 304 of the attachment mechanism 300.

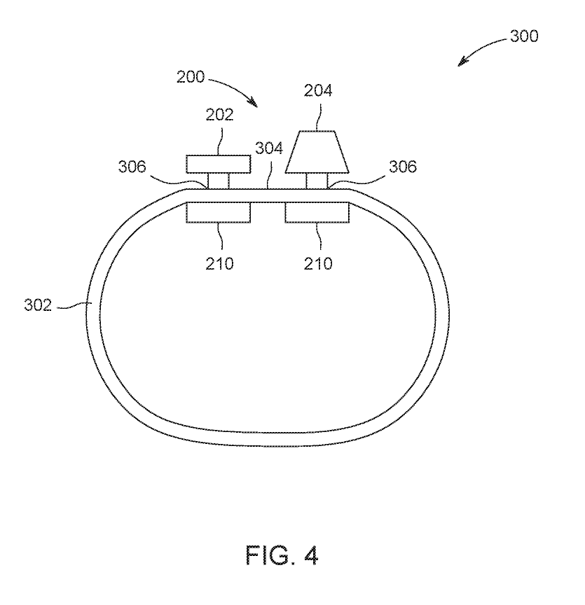

FIG. 4 is a side view of exemplary customizable user interface controls 200 provided in an exemplary attachment mechanism 300, in accordance with various embodiments. The customizable user interface controls 200 of FIG. 2 may correspond with the custom user input module 128 of FIG. 1. Referring to FIG. 4, customizable user interface controls 200 are detachably coupled to an attachment mechanism 300. The customizable user interface controls 200 comprise a user input portion 202, 204 and a base portion 210. The attachment mechanism comprises a band portion 302 and a mounting portion 304 having mounting elements 306 for detachably coupling the custom user input module 128, 200 to the attachment mechanism 300. For example, the custom user input modules 200 may extend through an aperture 306 of the mounting portion 304 to detachably couple to the mounting portion 304 of the attachment mechanism 300. The customizable user interface controls 200 illustrated in FIG. 4 shares various characteristics with the customizable user interface controls 128, 200 illustrated in FIGS. 1-2 as described above. The attachment mechanism 300 illustrated in FIG. 4 shares various characteristics with the attachment mechanism 300 illustrated in FIG. 3 as described above.

Referring again to FIG. 1, the custom user input module 128 is configured to communicate with the ultrasound system 100 via a custom user input receiver 131 of the ultrasound system 100. The custom user input receiver(s) 131 include physical devices for receiving signals from at least the custom user input module(s) 128. The custom user input receiver(s) 131 may be provided at fixed locations at the ultrasound system 100 and are communicatively coupled with the signal processor 132. For example, the custom user input module 128 may include a transmitter for wirelessly communicating with the ultrasound system 100 via the custom user input receiver 131. The custom user input module 128 and custom user input receiver 131 may communicate using near field communication (NFC), Bluetooth, Wi-Fi, or any suitable wireless technology. In various embodiments, the transmitter of the custom user input module 128 and the receiver 131 of the medical imaging system 100 may be transceivers operable to provide bi-directional communication. Additionally and/or alternatively, each of the custom user input module 128 and the medical imaging system 100 may include both transmitters and receivers.

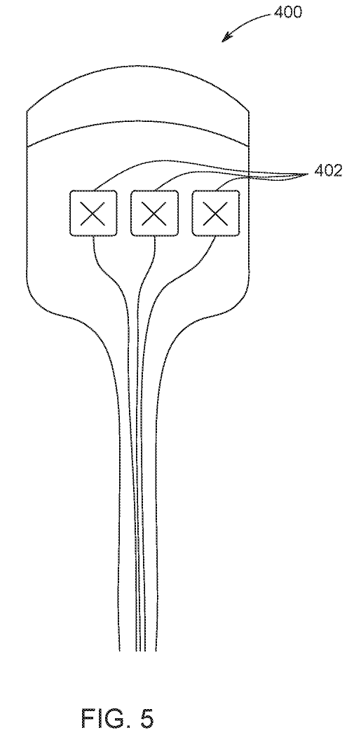

FIG. 5 is a cross-sectional view of an exemplary ultrasound probe 400 having receivers 402 configured to cooperate with transmitters 210 of customizable user interface controls 128, 200, in accordance with various embodiments. The ultrasound probe 400 and receivers 402 of FIG. 5 may correspond with the ultrasound probe 104 and custom user input receiver 131, respectively, of FIG. 1. Referring to FIG. 5, the ultrasound probe 400 comprises receivers 402 disposed within the probe 400. The receivers 402 may be positioned at various locations within the probe 400 such that an ultrasound operator may selectively place customizable user interface controls 128, 200 at convenient, comfortable, and/or otherwise desirable positions on the probe 400 such that the receivers 402 may receive the signals transmitted by the custom user input modules 128, 200. Although three receivers 402 are shown in FIG. 5 more or less receivers 402 are contemplated. For example, the probe 400 may include one, two, four, five, or any suitable number of receivers 402. The receivers may be configured to communicate using near field communication (NFC), Bluetooth, Wi-Fi, or any suitable wireless technology. The signals received at the receivers 402 may be provided to a signal processor 132 and/or custom user input control detection module 140 of the ultrasound system 100 as described below.

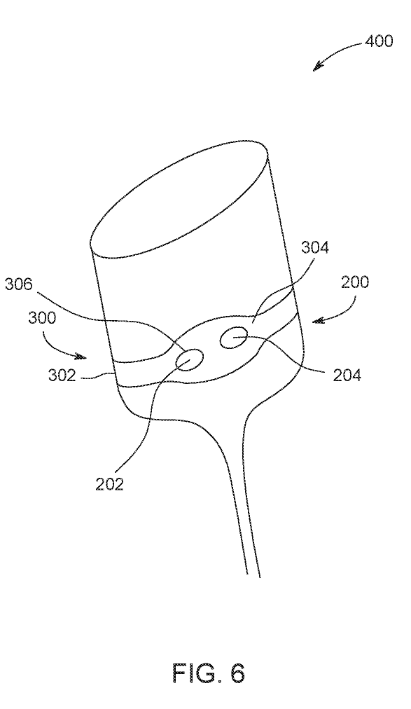

FIG. 6 is a perspective view of an exemplary ultrasound probe 400 having exemplary customizable user interface controls 200 positioned on the probe 400 by an exemplary attachment mechanism 300, in accordance with various embodiments. The ultrasound probe 400 and customizable user interface controls 200 of FIG. 6 may correspond with the ultrasound probe 104 and custom user input module 128, respectively, of FIG. 1. Referring to FIG. 6, customizable user interface controls 200 are detachably coupled to an attachment mechanism 300 selectively positionable on an ultrasound probe 400. The customizable user interface controls 200 each comprises a user input portion 202, 204, such as a button 202, rotary encoder 204, slider, or the like. The attachment mechanism 300 comprises a band portion 302 and a mounting portion 304. The band portion 302 is configured to wrap around the ultrasound probe 400 to secure the attachment mechanism 300 to the probe 400. The mounting portion 304 is attached and/or integrated with the band portion and comprises mounting elements 306 for detachably coupling the custom user input modules 200 to the attachment mechanism 300. The ultrasound probe 400 comprises receivers 402 disposed within the probe 400.

In various embodiments, an ultrasound operator may attach the custom user input modules 200 to the attachment mechanism 300 and secure the attachment mechanism 300 to the ultrasound probe 400 such that the custom user input modules 200 are positioned as desired by the ultrasound operator. The custom user input modules 200 may transmit signals in response to user operation of the custom user input modules 200. The signals transmitted by the custom user input modules 200 may be received by receivers 402 disposed in the ultrasound probe and provided to a signal processor 132 and/or custom user input control detection module 140 of the ultrasound system 100 as described below.

The customizable user interface controls 200 illustrated in FIG. 6 shares various characteristics with the customizable user interface controls 128, 200 illustrated in FIGS. 1-2 and 4 as described above. The attachment mechanism 300 illustrated in FIG. 6 shares various characteristics with the attachment mechanism 300 illustrated in FIGS. 3-4 as described above. The ultrasound probe 400 illustrated in FIG. 6 shares various characteristics with the ultrasound probe 104, 400 illustrated in FIGS. 1 and 5 as described above.

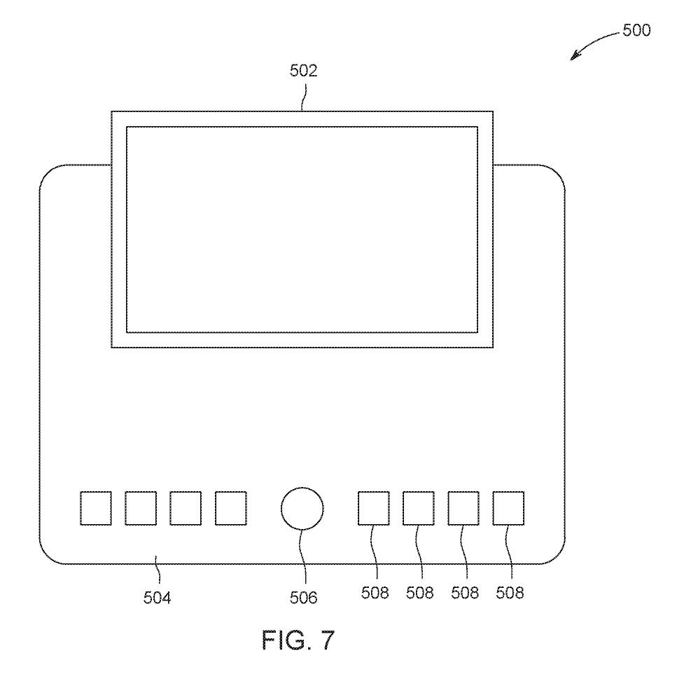

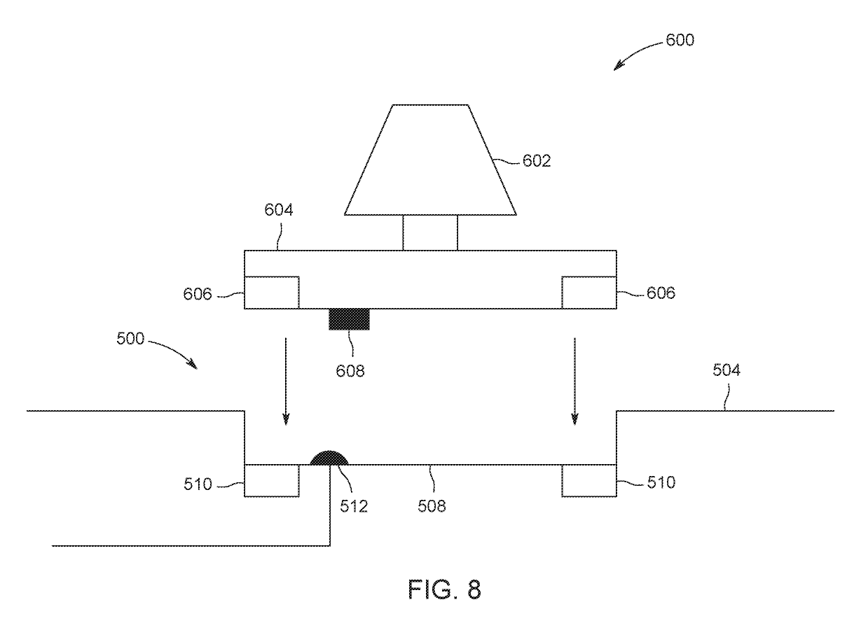

Referring again to FIG. 1, in certain embodiments, the custom user input receiver 131 may include contacts configured to connect with contacts of a custom user input module 128. FIG. 7 is a front view of an exemplary ultrasound system control panel 500 having slots 508 for receiving customizable user interface controls 128, in accordance with various embodiments. FIG. 8 is a cross-sectional view of an exemplary ultrasound system control panel 500 receiving a customizable user interface control 600, in accordance with various embodiments. Referring to FIGS. 7-8, an ultrasound system control panel 500 comprises a monitor 502 and console portion 504. In various embodiments, the monitor 502 of FIG. 7 may correspond with the user input module 130 and/or the display system 134 of FIG. 1. The console portion 504 may comprise a trackball 504 and slots 508 configured to receive custom user input modules 600. In various embodiments, the trackball 506 of FIG. 8 may correspond with the user input module 130 of FIG. 1. The slots 508 in the console portion 504 may provide a plurality of position options for receiving custom user input modules 600 such that a medical image device operator may selectively place different custom user input modules 600 at convenient, comfortable, and/or other desirable locations. The slots 508 may comprise mechanisms 510 for securing the custom user input modules 600 within the slots 508 and mechanisms 512 for receiving signals transmitted by the custom user input modules 600. For example, the mechanisms for securing the custom user input modules 600 may include magnets 510, hook and loop fasteners, clips, snaps, or any suitable attachment mechanism. The mechanisms for receiving signals may include electrical contacts 512, plugs, ports, sockets, wireless receivers, or any suitable mechanism for receiving a signal.

Referring to FIG. 8, the customizable user interface control 600 comprises a user input portion 602 and a base portion 604. The user input portion 602 may be a button, rotary encoder 602, slider, or any suitable device or mechanism operable to receive a user input. The user input portion 602 is configured to generate a signal in response to receiving a user input, such as a press action, rotary action, sliding action, or the like. The base portion 604 may comprise mechanisms 606 for securing the custom user input modules 600 within the slots 508 and mechanisms 608 for transmitting the signals generated by the user input portion 602. For example, the mechanisms for securing the custom user input modules 600 may include magnets 606, hook and loop fasteners, clips, snaps, or any suitable attachment mechanism. The mechanisms for transmitting signals may include electrical contacts 608, plugs, ports, sockets, wireless transmitters, or any suitable mechanism for transmitting a signal. In certain embodiments, the base portion 604 may include a battery for powering the customizable user interface control 600. Additionally and/or alternatively, the customizable user interface control 600 may be powered: (1) via the electrical contacts 608, plugs, ports, sockets, or the like, (2) by induction when the control 600 is placed in the slot 500 of the control panel 500, (3) by harvesting energy from operation of the control 600, such as by pressing or turning the control 600, and/or (4) by any suitable mechanism for providing power to the control 600. In certain embodiments, the base portion 604 of the user input module 600 may be mounted within a convenient one of the slots 508 in the console portion 504 of the control panel 500. In various embodiments, the customizable user interface control 600 of FIG. 8 may correspond with the custom user input module 128 of FIG. 1.

Referring again to FIG. 1, the signal processor 132 may comprise suitable logic, circuitry, interfaces and/or code that may be operable to control operation of the ultrasound system 100 and process the ultrasound scan data for generating an ultrasound image for presentation on a display system 134. The signal processor 132 is operable to perform one or more processing operations according to a plurality of selectable ultrasound modalities on the acquired ultrasound scan data. Acquired ultrasound scan data may be processed in real-time during a scanning session as the echo signals are received. Additionally or alternatively, the ultrasound scan data may be stored temporarily in the RF/IQ buffer 126 during a scanning session and processed in less than real-time in a live or off-line operation. In the exemplary embodiment, the signal processor 132 may comprise a custom user input control detection module 140 configured to detect custom user input modules 128 and a control-action-mapping module 150 configured to map the functionality of the detected custom user input modules 128 to actions of the ultrasound system 100 as described below.

The ultrasound system 100 may be operable to continuously acquire ultrasound information at a frame rate that is suitable for the imaging situation in question. Typical frame rates range from 20-70 but may be lower or higher. The acquired ultrasound information may be displayed on the display system 134 at a display-rate that can be the same as the frame rate, or slower or faster. An image buffer 136 is included for storing processed frames of acquired ultrasound information that are not scheduled to be displayed immediately. Preferably, the image buffer 136 is of sufficient capacity to store at least several seconds worth of frames of ultrasound information. The frames of ultrasound information are stored in a manner to facilitate retrieval thereof according to its order or time of acquisition. The image buffer 136 may be embodied as any known data storage medium.

The custom user input control detection module 140 may comprise suitable logic, circuitry, interfaces and/or code that may be operable to detect custom user input modules 128 attempting to connect with the ultrasound system 100. For example, a custom user input module 128 may transmit a signal to attempt to connect with an ultrasound system 100. The custom user input receiver 131 of the ultrasound system 100 may receive the transmitted signal and provide it to the custom user input control detection module 140 of the signal processor 132. The detection module 140 may decode the received signal and analyze the received information provided in the signal to determine whether an authorized custom user input module 128 configured to connect to the ultrasound system 100 has been detected. The information provided in the signal may include identification information and the type of the input device, among other things. If the detection module 140 determines that the received signal corresponds to a custom user input module 128 capable of and/or authorized to connect to the ultrasound system 100, the detection module 140 may be configured to provide the device information to a control-action-mapping module 150 configured to map the functionality of the detected custom user input modules 128 to actions of the ultrasound system 100. The detection module 140 may be configured to provide a configuration dialog 138 to allow the ultrasound operator to configure the detected custom user input module 128.

The configuration dialog 138 may comprise suitable logic, circuitry, interfaces and/or code that may be operable to present custom user input modules 128 configuration options. The configuration dialog may be presented at the display system 134 or any suitable user interface. The configuration dialog 138 may present options for associating the functionality of the custom user input module 128 with actions of the ultrasound system 100. For example, a rotary encoder 128 may be configured at the configuration dialog 138 to change an image contrast based on rotary action of the rotary encoder 128 and to trigger freeze and run scanning actions based on a press action of the rotary encoder 128.

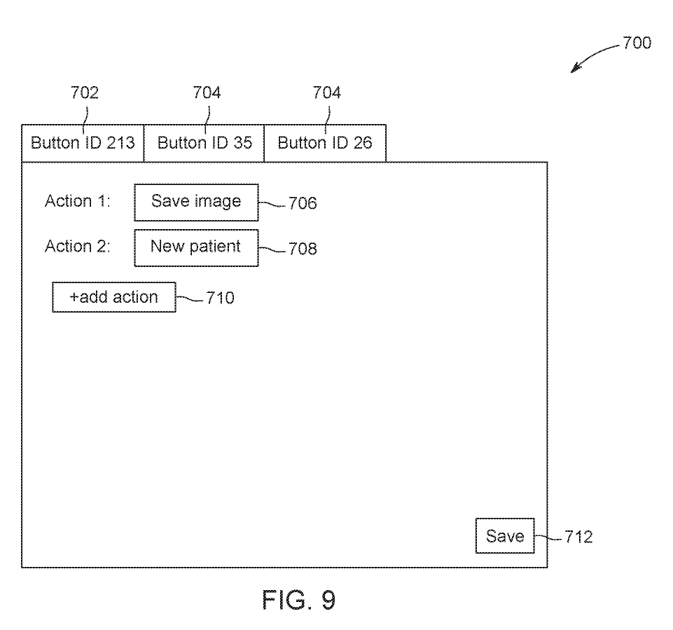

FIG. 9 is a screenshot of an exemplary configuration dialog 700 configured to present configuration options of a customizable user interface control 128, in accordance with various embodiments. The configuration dialog 700 of FIG. 9 may correspond with the configuration dialog 138 of FIG. 1. Referring to FIG. 9, the configuration dialog 700 may comprise at least one selectable customizable user interface control tabs or pages 702, 704, each of which is associated with one customizable user interface control 128. The pages 702, 704 may each include one or more user-definable medical imaging system actions for a corresponding customizable user interface control 128. For example, FIG. 9 illustrates three customizable user interface controls 128 each having a page 702, 704 for defining the configuration options. The selected page 702 is associated with the Button ID 213 user interface control 128 and the non-selected pages 704 are associated with the Button ID 35 and Button ID 26 controls 128. The selected page 702 provides medical imaging device actions that may be selected by a selection prompt 706, 708, such as a drop-down list, check boxes, text fields, or any suitable selection prompt. As an example, FIG. 9 illustrates a first selected medical imaging action 706 for saving an image and a second selected medical imaging action 708 for identifying a new patient.

In various embodiments, the actions may correspond with different available input actions of the customizable user interface control 128. For example, a rotary encoder may include rotary actions and a press action. As another example, buttons may include press actions. In various embodiments, the actions may additionally and/or alternatively correspond with different clinical applications or stages within a clinical application. For example, the user interface control 128 may have a first action or set of actions during an image acquisition stage and a second action or set of actions during image analysis stage. The pages 702, 704 of the user-definable medical imaging system actions for a corresponding customizable user interface control 128 may include an add action button 710 and save button 712. The add action button 710 is configured to add additional medical imaging system actions for the corresponding customizable user interface control 128. The save button 712 is configured to send the selected settings presented on the page 702 corresponding with the customizable user interface control 128 to the control-action-mapping module 150 of the signal processor for implementing the user-defined settings.

Referring again to FIG. 1, the control-action-mapping module 150 may comprise suitable logic, circuitry, interfaces and/or code that may be operable to map, store, retrieve, and apply actions of the ultrasound system 100 based on the functionality of the user input module(s) 130 and detected custom user input module(s) 128. For example, the control-action-mapping module 150 may receive custom user input module 128 identification information and the type of the input device, among other things, from the control detection module. Moreover, the control-action-mapping module 150 may receive configuration settings provided by an operator at the configuration dialog 138. The custom user input module 128 device information and configuration settings may be stored by the control-action-mapping module 150. The user input module 130 device information and configuration settings may also be stored by the control-action-mapping module 150. The control-action-mapping module 150 applies the appropriate ultrasound system action associated with a particular custom user input module 128 and/or user input module 130 in response to an ultrasound operator providing a user input at the custom user input module 128 and/or user input module 130. For example, if the control-action-mapping module 150 receives a clockwise rotary action of a rotary encoder custom user input module 128 and the clockwise rotary action of that input module 128 was associated with an increase image contrast action by an ultrasound operator, the control-action-mapping module controls the ultrasound system 100 to apply the increase in image contrast as directed by the rotary encoder custom user input module 128.

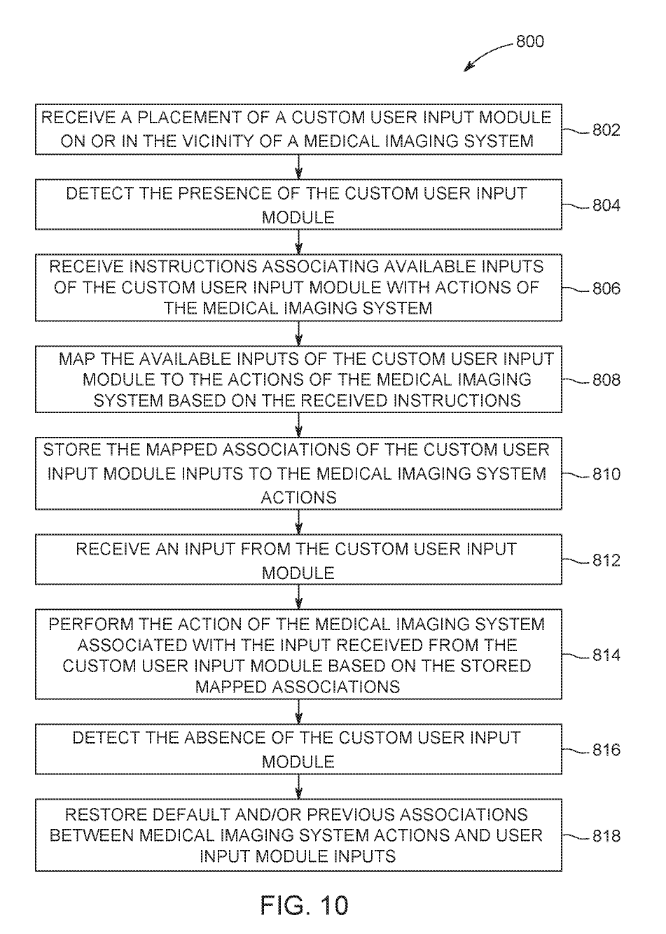

FIG. 10 is a flow chart 800 illustrating exemplary steps 802-818 that may be utilized for positioning, configuring, and controlling a medical imaging system 100 using customizable user interface controls 128, 200, 600, in accordance with various embodiments. Referring to FIG. 10, there is shown a flow chart 800 comprising exemplary steps 802 through 818. Certain embodiments may omit one or more of the steps, and/or perform the steps in a different order than the order listed, and/or combine certain of the steps discussed below. For example, some steps may not be performed in certain embodiments. As a further example, certain steps may be performed in a different temporal order, including simultaneously, than listed below.

At step 802, a custom user input module 128 may be placed on or in the vicinity of a medical imaging system 100. For example, a medical imaging system operator may position the custom user input module 128 at locations that are convenient, comfortable, and/or other desirable for the operator. The custom user input module 128 is a physical control device, such as a button, rotary encoder, slider, among other things, that may be added to a medical imaging system 100 at user-selected locations on or near the medical imaging system 100. For example, the custom user input module 128 may be mounted to or near the medical imaging system 100 via an attachment mechanism, such as magnets, hook and loop fasteners, clips, snaps, bands, straps, or any suitable attachment mechanism. The flexible positionability of the custom user input module 128 may better accommodate left-handed users, users with disabilities, and the like. The custom user input module 128 may be configured for use with multiple imaging systems 100. For example, a user may carry their own custom user input module 128 with them for use at different medical imaging systems 100 in different examination rooms, among other things.

At step 804, a signal processor 132 of a medical imaging system 100 may detect the presence of the custom user input module 128. For example, a custom user input module 128 may transmit a signal to attempt to connect with the medical imaging system 100. The medical imaging system 100 may receive the transmitted signal via a receiver 131 and provide it to a custom user input control detection module 140 of the signal processor 132. The detection module 140 may analyze information provided in the received signal, such as identification information and the type of the input device, to determine whether an authorized custom user input module 128 has been detected. The detection module 140 may be configured to provide the device information to a control-action-mapping module 150 of the signal processor 132 configured to register the detected module 128 and may provide a configuration dialog 138 to allow the ultrasound operator to configure the detected custom user input module 128 if the detection module 140 determines that the received signal corresponds to a custom user input module 128 capable of and/or authorized to connect to the medical imaging system 100.

At step 806, the signal processor 132 may receive instructions associating available inputs of the custom user input module 128 with actions of the medical imaging system 100. For example, a medical imaging system operator may selectively assign custom user input module 128 inputs with medical imaging system 100 actions via the configuration dialog 138 presented to the operator. The configuration dialog 138 may present options for associating the functionality of the custom user input module 128 with actions of the ultrasound system 100. As an example, a custom user input module button 128 may be configured at the configuration dialog 138 to trigger freeze and run scanning actions based on a press action of the button 128.

At step 808, the signal processor 132 may map the available inputs of the custom user input module 128 to the actions of the medical imaging system 100 based on the received instructions. For example, the control-action-mapping module 150 of the signal processor 132 may receive the configuration settings provided by an operator of the medical imaging system 100 at the configuration dialog 138. The control-action-mapping module 150 may associate the custom user input module 128 functionality to the actions of the medical imaging system 100 based on the configuration settings provided by the operator and the identification information and the type of the input device received from the control detection module 140.

At step 810, the signal processor 132 may store the mapped associations of the custom user input module 128 inputs to the medical imaging system 100 actions. For example, the custom user input module 128 device information and configuration settings may be stored by the control-action-mapping module 150 of the signal processor 132. In various embodiments, the control-action-mapping module 150 may manage the storage of the custom user input module 128 configuration settings and the configuration settings of the user input module 130.

At step 812, the signal processor 132 may receive an input from the custom user input module 128. For example, a medical imaging system operator may provide a user input at the custom user input module 128. The input may be encoded in a signal and transmitted by a transmitter of the custom user input module 128 to a receiver 131 of the medical imaging system 100. The mechanisms for transmitting and receiving the signal may include, for example, wireless transmitters/receivers, electrical contacts, plugs/sockets, or any suitable mechanisms for transmitting and receiving a signal. In various embodiments, wireless communication is preferable to provide additional custom user input module 128 placement flexibility, among other things. The custom user input module 128 and receiver 131 may communicate using near field communication (NFC), Bluetooth, Wi-Fi, or any suitable wireless technology. The signal received by the receiver 131 of the medical imaging system 100 is provided to the signal processor 132. In various embodiments, the transmitter of the custom user input module 128 and the receiver 131 of the medical imaging system 100 may be transceivers operable to provide bi-directional communication. Additionally and/or alternatively, each of the custom user input module 128 and the medical imaging system 100 may include both transmitters and receivers.

At step 814, the signal processor 132 may perform the action of the medical imaging system 100 associated with the input received from the custom user input module 128 based on the stored mapped associations. The control-action-mapping module 150 of the signal processor 132 receives the input provided at step 812 and applies the appropriate medical imaging system action associated with the custom user input module 128 that provided the input based on the associations mapped at step 808 and stored at step 810. For example, if the control-action-mapping module 150 receives a press action of a button custom user input module 128 at step 812 and the press action of that input module 128 was associated with a save image action by a medical imaging system operator at steps 808 and 810, the control-action-mapping module controls the medical imaging system 100 to save the image as directed by the button custom user input module 128 at step 814. In various embodiments, the signal processor 132 may transmit information to the custom user input module 128. For example, the signal processor 132 may provide feedback related to the action performed at step 814. The feedback may include communication acknowledgement messages and/or signals that provide a user indication via the custom user input module 128. The user indication can include light indications, text indications, sound indications, and/or the like.

At step 816, the signal processor 132 may detect the absence of the custom user input module 128. For example, a medical imaging system operator may disconnect the custom user input module 128 from the medical imaging system 100. The disconnection may be in response to an instruction provided to the medical imaging system 100 via the custom user input module 128 and/or a user input module 130, powering off the custom user input module 128, moving the custom user input module 128 out of a wireless range of a receiver 131 of the medical imaging system 100, and/or breaking an electrical connection between the custom user input module 128 and a receiver 131 of the medical imaging system 100, among other things.

At step 818, the signal processor 132 may restore default and/or previous associations between medical imaging system 100 actions and user input module 130 inputs and/or other custom user input module 128 inputs. For example, the control-action-mapping module 150 may delete the stored associations between the removed custom user input module 128 and, if applicable, revert to previous associations and/or default associations between the input modules 128, 130 functionality and actions of the medical imaging device 100. Additionally and/or alternatively, the signal processor 132 may present the configuration dialog 138 to allow the operator to update the configuration settings of the input modules 128, 130.

Aspects of the present invention provide a method 800 and system 100 for providing customizable user interface controls 128, 200, 600 that can be positioned at multiple locations on and/or around an ultrasound system 100 or other medical imaging system. In accordance with various embodiments, the method 800 comprises receiving 802, one or both of at a medical imaging system 100 or in communication range of the medical imaging system 100, a selective placement of a custom user input module 128, 200, 600 having at least one input functionality. The method 800 comprises detecting 804, by a signal processor 132, 140 of the medical imaging system 100, a presence of the custom user input module 128, 200, 600 to establish a connection between the custom user input module 128, 200, 600 and the medical imaging system 100. The method 800 comprises receiving 806, by the signal processor 132, 150, instructions associating each of the at least one input functionality of the custom user input module 128, 200, 600 with an action of the medical imaging system 100. The method 800 comprises mapping 808, by the signal processor 132, 150, each of the at least one input functionality with the action of the medical imaging system 100 based on the received instructions. The method 800 comprises receiving 812, by the signal processor 132, 150, a signal corresponding with the at least one input functionality of the custom user input module 128, 200, 600. The method 800 comprises executing 814, by the signal processor 132, 150, the action of the medical imaging system 100 mapped to the at least one input functionality of the custom user input module 128, 200, 600 based on the received signal.

In various embodiments, the custom user input module 128, 200, 600 comprises a user input portion 202, 204, 602 and a base portion 210, 604. The user input portion 202, 204, 602 is operable to receive a user input corresponding with the at least one input functionality. The base portion 210, 604 is configured to transmit the signal corresponding with the at least one input functionality. In certain embodiments, the custom user input module 128, 200, 600 is one or both of integrated with or coupled to an attachment mechanism 300, 606 configured to mount the custom user input module 128, 200, 600 at the selective placement. In a representative embodiment, the attachment mechanism 300, 606 comprises one or more of magnets 606, hook and loop fasteners 606, clips 606, snaps 606, bands 302, and straps 302.

In certain embodiments, the medical imaging system 100 is an ultrasound system 100 comprising a receiver 131, 402, 512 configured to receive the signal transmitted from the base portion 210, 604 of the custom user input module 128, 200, 600 and provide the signal to the signal processor 132, 150. In a representative embodiment, the signal transmitted from the base portion 210, 604 of the custom user input module 128, 200, 600 and received by the receiver 131, 402, 512 of the medical imaging system 100 is one or more of a near field communication (NFC) signal, a Bluetooth signal, or a Wi-Fi signal. In certain embodiments, the ultrasound system 100 comprises a probe 104, 400. The receiver 131, 402, 512 is a wireless receiver 131, 402 disposed within the probe 104, 400.

In a representative embodiment, the ultrasound system 100 comprises a control panel 500 having a plurality of slots 508 configured to receive the selective placement of the custom user input module 128, 200, 600. The receiver 131, 402, 512 is one or more of an electrical contact 512, a plug 512, a port 512, a socket 512, or a wireless receiver 402 disposed within at least one of the plurality of slots 508. In certain embodiments, the instructions associating each of the at least one input functionality with the action of the medical imaging system 100 are provided in response to user configuration settings 706, 708 input via a configuration dialog user interface 138, 700.

Various embodiments provide a system comprising a custom user input module 128, 200, 600 having at least one input functionality and a medical imaging system 100. The custom user input module 128, 200, 600 is configured to be selectively placed one or both of at a medical imaging system 100 or in communication range of the medical imaging system 100. The medical imaging system 100 comprises a signal processor 132, 140, 150. The signal processor 132, 140 is configured to detect a presence of the custom user input module 128, 200, 600 to establish a connection between the custom user input module 128, 200, 600 and the medical imaging system 100. The signal processor 132, 150 is configured to receive instructions associating each of the at least one input functionality of the custom user input module 128, 200, 600 with an action of the medical imaging system 100. The signal processor 132, 150 is configured to map each of the at least one input functionality with the action of the medical imaging system 100 based on the received instructions. The signal processor 132, 150 is configured to receive a signal corresponding with the at least one input functionality of the custom user input module 128, 200, 600. The signal processor 132, 150 is configured to execute the action of the medical imaging system 100 mapped to the at least one input functionality of the custom user input module 128, 200, 600 based on the received signal.

Certain embodiments provide a non-transitory computer readable medium having a stored thereon, a computer program having at least one code section that is executable by a machine for causing the machine to perform steps 200 disclosed herein. Exemplary steps 800 may comprise detecting 804 a presence of a custom user input module 128, 200, 600 having at least one input functionality to establish a connection between the custom user input module 128, 200, 600 and the medical imaging system 100. The steps 800 may comprise receiving 806 instructions associating each of the at least one input functionality of the custom user input module 128, 200, 600 with an action of the medical imaging system 100. The steps 800 may comprise mapping 808 each of the at least one input functionality with the action of the medical imaging system 100 based on the received instructions. The steps 800 comprise receiving 812 a signal corresponding with the at least one input functionality of the custom user input module 128, 200, 600. The steps 800 comprise executing 814 the action of the medical imaging system 100 mapped to the at least one input functionality of the custom user input module 128, 200, 600 based on the received signal.

In a representative embodiment, the steps 800 comprise presenting a configuration dialog user interface 138 in response to the detecting 804 the presence of the custom user input module 128, 200, 600. The instructions associating each of the at least one input functionality with the action of the medical imaging system 100 are provided in response to user configuration settings 706, 708 input via the configuration dialog user interface 138, 700.

As utilized herein the term “circuitry” refers to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

Other embodiments may provide a computer readable device and/or a non-transitory computer readable medium, and/or a machine readable device and/or a non-transitory machine readable medium, having stored thereon, a machine code and/or a computer program having at least one code section executable by a machine and/or a computer, thereby causing the machine and/or computer to perform the steps as described herein for providing customizable user interface controls that can be positioned at multiple locations on and/or around an ultrasound system or other medical imaging system.

Accordingly, various embodiments may be realized in hardware, software, or a combination of hardware and software. Various embodiments may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

Various embodiments may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While various embodiments have been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method, comprising:
receiving, one or both of at a medical imaging system or in communication range of the medical imaging system, a selective placement of a custom user input module having at least one input functionality;
detecting, by a signal processor of the medical imaging system, a presence of the custom user input module to establish a connection between the custom user input module and the medical imaging system;
receiving, by the signal processor, instructions associating each of the at least one input functionality of the custom user input module with an action of the medical imaging system;
mapping, by the signal processor, each of the at least one input functionality with the action of the medical imaging system based on the received instructions;
receiving, by the signal processor, a signal corresponding with the at least one input functionality of the custom user input module; and
executing, by the signal processor, the action of the medical imaging system mapped to the at least one input functionality of the custom user input module based on the received signal.

2. The method according to claim 1, wherein the custom user input module comprises:
a user input portion operable to receive a user input corresponding with the at least one input functionality, and
a base portion configured to transmit the signal corresponding with the at least one input functionality.

3. The method according to claim 2, wherein the custom user input module is one or both of integrated with or coupled to an attachment mechanism configured to mount the custom user input module at the selective placement.

4. The method according to claim 3, wherein the attachment mechanism comprises one or more of:
magnets,
hook and loop fasteners, clips,
snaps,
bands, and
straps.

5. The method according to claim 2, wherein the medical imaging system is an ultrasound system comprising a receiver configured to receive the signal transmitted from the base portion of the custom user input module and provide the signal to the signal processor.

6. The method according to claim 5, wherein the signal transmitted from the base portion of the custom user input module and received by the receiver of the medical imaging system is one or more of:
a near field communication (NFC) signal,
a Bluetooth signal, or
a Wi-Fi signal.

7. The method according to claim 5, wherein the ultrasound system comprises a probe, and wherein the receiver is a wireless receiver disposed within the probe.

8. The method according to claim 5, wherein the ultrasound system comprises a control panel having a plurality of slots configured to receive the selective placement of the custom user input module, and wherein the receiver is one or more of:
an electrical contact,
a plug,
a port,
a socket, or
a wireless receiver
disposed within at least one of the plurality of slots.

9. The method according to claim 1, wherein the instructions associating each of the at least one input functionality with the action of the medical imaging system are provided in response to user configuration settings input via a configuration dialog user interface.

10. A system, comprising:
a custom user input module having at least one input functionality, wherein the custom user input module is configured to be selectively placed one or both of at a medical imaging system or in communication range of the medical imaging system; and
the medical imaging system comprising:
a signal processor configured to:
detect a presence of the custom user input module to establish a connection between the custom user input module and the medical imaging system;
receive instructions associating each of the at least one input functionality of the custom user input module with an action of the medical imaging system;
map each of the at least one input functionality with the action of the medical imaging system based on the received instructions;
receive a signal corresponding with the at least one input functionality of the custom user input module; and
execute the action of the medical imaging system mapped to the at least one input functionality of the custom user input module based on the received signal.

11. The system according to claim 10, wherein the custom user input module comprises:
a user input portion operable to receive a user input corresponding with the at least one input functionality, and
a base portion configured to transmit the signal corresponding with the at least one input functionality.

12. The system according to claim 11, wherein the custom user input module is one or both of integrated with or coupled to an attachment mechanism configured to mount the custom user input module at the selective placement.

13. The system according to claim 12, wherein the attachment mechanism comprises one or more of:
magnets,
hook and loop fasteners, clips,
snaps,
bands, and
straps.

14. The system according to claim 11, wherein the medical imaging system is an ultrasound system comprising a receiver configured to receive the signal transmitted from the base portion of the custom user input module and provide the signal to the signal processor.

15. The system according to claim 14, wherein the signal transmitted from the base portion of the custom user input module and received by the receiver of the medical imaging system is one or more of:
a near field communication (NFC) signal,
a Bluetooth signal, or
a Wi-Fi signal.

16. The system according to claim 14, wherein the ultrasound system comprises a probe, and wherein the receiver is a wireless receiver disposed within the probe.

17. The system according to claim 14, wherein the ultrasound system comprises a control panel having a plurality of slots configured to receive the selective placement of the custom user input module, and wherein the receiver is one or more of:
an electrical contact,
a plug,
a port,
a socket, or
a wireless receiver
disposed within at least one of the plurality of slots.

18. The system according to claim 10, wherein the instructions associating each of the at least one input functionality with the action of the medical imaging system are provided in response to user configuration settings input via a configuration dialog user interface.

19. A non-transitory computer readable medium having stored thereon, a computer program having at least one code section, the at least one code section being executable by a machine for causing the machine to perform steps comprising:
detecting a presence of a custom user input module having at least one input functionality to establish a connection between the custom user input module and the medical imaging system;
receiving instructions associating each of the at least one input functionality of the custom user input module with an action of the medical imaging system;
mapping each of the at least one input functionality with the action of the medical imaging system based on the received instructions;
receiving a signal corresponding with the at least one input functionality of the custom user input module; and
executing the action of the medical imaging system mapped to the at least one input functionality of the custom user input module based on the received signal.

20. The non-transitory computer readable medium according to claim 19, comprising presenting a configuration dialog user interface in response to the detecting the presence of the custom user input module, wherein the instructions associating each of the at least one input functionality with the action of the medical imaging system are provided in response to user configuration settings input via the configuration dialog user interface.
